(19) United States
(12) Patent Application Publication
(10) Pub. No.: US 2009/0117336 A1
(43) Pub. Date: May 7, 2009

(54) CIRCUIT BOARD, METHOD FOR MANUFACTURING SUCH CIRCUIT BOARD, AND ELECTRONIC COMPONENT USING SUCH CIRCUIT BOARD

(75) Inventors: Takumi Usui, Kyoto (JP); Kaoru Yamashita, Kyoto (JP); Yasuo Asai, Kyoto (JP); Tomoyuki Futakawa, Kyoto (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD, Kadoma-shi, Osaka (JP)

(21) Appl. No.: 11/916,210

(22) PCT Filed: Jun. 1, 2005
(86) PCT No.: PCT/JP2005/010045

§ 371 Date: Nov. 30, 2007

(51) Int. Cl. B32B 7/12; B32B 38/04

(52) U.S. Cl. 428/172; 156/252

(57) ABSTRACT

The present invention provides a circuit board in which the through hole is highly hermetically sealed, a manufacturing method thereof, and an electronic component including the same. A circuit board (1) including an insulating substrate (10), and a through hole (11) that is formed in the thickness direction of the insulating substrate (10) for connecting a first main surface (10a) of the insulating substrate (10) to a second main surface (10b) of the insulating substrate (10) includes a conductive film (12) that is formed on the inner wall of the through hole (11) and around the openings of the through hole (11) on the first and second main surfaces (10a, 10b), and a filler (14) that is filled in the through hole (11). The filler (14) is filled in a non-foamed state.

### TECHNICAL FIELD

The present invention relates to a circuit board on which a quartz strip, semiconductor element, or the like is mounted, a manufacturing method thereof, and an electronic component using the same.

### BACKGROUND ART

As a conventional method for hermetically sealing through holes of a circuit board, there is a method in which a glass paste is filled into through holes (see, for example, Patent Document 1). FIGS. 5A to 5C are cross sectional views used to illustrate the conventional method of hermetically sealing a through hole described in Patent Document 1. First, as shown in FIG. 5A, a through hole 102 is formed in the thickness direction of an insulating substrate 101 by means of a blasting process, or the like. Subsequently, as shown in FIG. 5B, a conductive film 103 is formed on the inner wall of the through hole 102 and around the openings of the through hole 102. Then, as shown in FIG. 5C, a filler 104 made of a glass paste is filled into the through hole 102, which then is baked to close the through hole 102.

Patent document 1: JP H05-67868A

However, according to the conventional method described above, when baking the filler 104, the binder resin contained in the filler 104 is foamed, so that the filler 104 becomes porous. As a result, the hermeticity of the through hole 102 becomes low, so that when a circuit board obtained by the above conventional method is applied to an electronic component such as a quartz oscillator, which will be described later, it may be difficult to retain the airtightness of the electronic component.

### DISCLOSURE OF INVENTION

Having been conceived in light of the problem described above, it is an object of the present invention to provide a circuit board in which the through hole is highly hermetically sealed, and a manufacturing method thereof, and an electronic component using the same.

A circuit board of the present invention includes an insulating substrate, and a through hole that is formed in the thickness direction of the insulating substrate for connecting a first main surface of the insulating substrate to a second main surface of the insulating substrate, wherein the circuit board includes: a conductive film that is formed on the inner wall of the through hole and around the openings of the through hole on the first and second main surface; and a filler that is filled in the through hole, the filler being filled in a non-foamed state.

A method for manufacturing a circuit board of the present invention is a method for manufacturing a circuit board including the steps of: forming a through hole in the thickness direction of the insulating substrate for connecting a first main surface of an insulating substrate to a second main surface of the insulating substrate; forming a conductive film on the inner wall of the through hole and around the openings of the through hole on the first and second main surfaces; and filling a filler into the through hole with the application of heat and pressure.

An electronic component of the present invention includes: a circuit board that includes an insulating substrate, and a through hole for connecting a first main surface of the insulating substrate to a second main surface of the insulating substrate that is formed in the thickness direction of the insulating substrate; an electronic element that is mounted on the circuit board; and a lid member that covers the electronic element, wherein the circuit board includes a conductive film that is formed on the inner wall of the through hole and around the openings of the through hole on the first and second main surfaces, and a filler that is filled in the through hole, and the filler is filled in a non-foamed state.

According to the circuit board of the present invention, the filler is filled in the through hole in a non-foamed state, and thus it is possible to provide a circuit board in which the through hole is highly hermetically sealed. Also, according to the electronic component of the present invention, because the above-described circuit board of the present invention is used, it is possible to provide an electronic component having high airtightness. Also, according to the method for manufacturing a circuit board of the present invention, the above-described circuit board of the present invention can be manufactured easily.

### BRIEF DESCRIPTION OF DRAWINGS

FIG. 1 is a cross sectional view of a circuit board according to Embodiment 1 of the present invention.

FIGS. 2A to 2G are cross sectional views used to illustrate an example of a method for manufacturing the circuit board according to Embodiment 1 of the present invention.

FIG. 3 is a cross sectional view of an electronic component according to Embodiment 2 of the present invention.

FIGS. 4A to 4C are cross sectional views used to illustrate an example of a method for manufacturing the electronic component according to Embodiment 2 of the present invention.

FIGS. 5A to 5C are cross sectional views used to illustrate a conventional method of hermetically sealing a through hole.

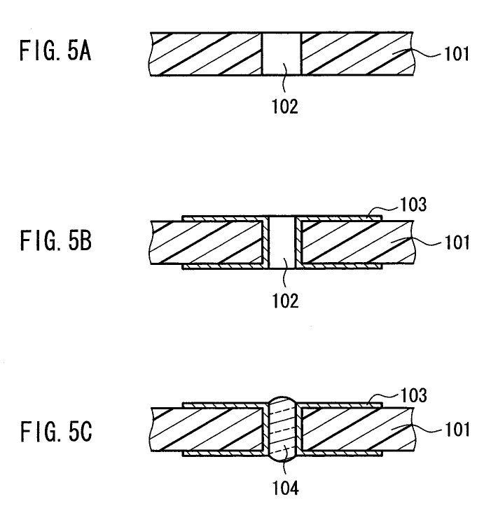

### BEST MODE FOR CARRYING OUT THE INVENTION

A circuit board of the present invention includes an insulating substrate, and a through hole for connecting a first main surface of the insulating substrate to a second main surface of the insulating substrate that is formed in the thickness direction of the insulating substrate. As used herein, the “first main surface” refers to a main surface on which an electronic element is to be mounted when the circuit board is applied to an electronic component, which will be described later.

It is preferable that the insulating substrate is a glass substrate. Because glass substrates have a structure that is formed of connected silicon oxide molecules and has no boundaries, glass substrates are formed more densely than ceramic substrates, and the like. Accordingly, when the insulating substrate is a glass substrate, and is applied to an electronic component, which will be described later, it is possible to improve the airtightness of the electronic component. As the glass substrate, for example, borosilicate glass having a thermal expansion coefficient of 3×10⁻⁶/° C. to 8×10⁻⁶/° C., alkali-free glass having the same thermal expansion coefficient of 3×10⁻⁶/° C. to 8×10⁻⁶/° C., soda glass having a thermal expansion coefficient of 8×10⁻⁶/° C. to 1.2×10⁻⁵/° C., or the like can be used. The thickness of the glass substrate is, for example, about 100 to 300 μm. The insulating substrate has, for example, a softening point of about 700 to 900° C.

It is preferable that the diameter of the through hole decreases gradually from the first main surface toward the second main surface. This is to facilitate the filling of a filler that is described later. The diameter of the through hole can be set to an appropriate value according to the thickness of the insulating substrate. For example, when the insulating substrate has a thickness of 150 μm, the diameter of the opening on the first main surface side may be set to fall within a range of 100 to 150 μm, and the diameter of the opening on the second main surface side may be set to fall within a range of 50 to 100 μm. The through hole can be formed by, for example, a sandblast method, etching method, or the like. Particularly, a sandblast method is preferable because through holes having a desired shape can be formed by adjusting the blast pressure, or the like, as appropriate.

The circuit board of the present invention includes a conductive film that is formed on the inner wall of the through hole and around the openings of the through hole on the first and second main surfaces, and a filler that is filled in the through hole. The filler is filled in a non-foamed state. Thereby, it is possible to provide a circuit board in which the through hole is highly hermetically sealed. Particularly, it is preferable that the filler filled in the through hole has a porosity of not greater than 20% (more preferably not greater than 10%) because the hermeticity of the through hole is improved further. The porosity of the filler can be determined by, for example, measuring the specific gravity of the filler, and calculating the ratio of this measured value and the specific gravity of the component material of the filler. The softening point of the filler is, for example, about 500 to 700° C.

Furthermore, in the present invention, when using a glass substrate as the insulating substrate, it is preferable that the filler is made of glass. Because the thermal expansion coefficient of the insulating substrate and that of the filler can be matched to a certain extent, it is possible to prevent the degradation of the hermeticity of the through hole caused by, for example, a thermal distortion.

Furthermore, in the present invention, when the filler is made of glass, it is preferable to use, as the conductive film, a thin film made of a metal on which an oxide coating film is formed easily, such as titanium or copper. Because the glass (composed mainly of an oxide) forming the filler and the oxide coating film that covers the conductive film firmly adhere to each other, the hermeticity of the through hole is improved further. The conductive film can be formed by means of, for example, a sputtering method, plating method, or the like. For example, when a titanium thin film is formed to have a thickness of about 0.05 to 0.1 μm, a sputtering method can be used. Alternatively, when a copper thin film is formed to have a thickness of about 1 to 2 μm, an electroless plating method, an electroplating method, or the like can be used.

Next, a method for manufacturing a circuit board of the present invention will be described. It should be noted that the description that overlaps that of the circuit board of the present invention described above may be omitted in the following description.

According to a method for manufacturing a circuit board of the present invention, first, a through hole is formed in the thickness direction of an insulating substrate to connect a first main surface to a second main surface of the insulating substrate. A conductive film is formed on the inner wall of this through hole and around the openings of the through hole on the first and second main surface. The methods for forming the through hole and the conductive film are described above. It is preferable that the through hole is formed such that the diameter of the through hole decreases gradually from the first main surface toward the second main surface. This is to facilitate the filling of a filler that is described later. Similarly to the circuit board of the present invention described above, the insulating substrate used preferably is a glass substrate.

Thereafter, a filler is filled into the through hole with the application of heat and pressure. Thereby, the filler is filled in a non-foamed state, so that a circuit board of the present invention as described above is obtained. Although the conditions for filling the filler vary according to the material of the filler, or the like, preferred filling conditions for the case when the filler is made of glass will be described later.

Furthermore, according to the method for manufacturing a circuit board of the present invention, the filler in a substantially spherical shape may be filled into the through hole because the conductive film formed on the inner wall of the through hole and the filler can be allowed to adhere uniformly to each other. In this case, the diameter of the filler to be filled may be set as appropriate according to the diameter of the opening of the through hole. For example, when the opening of the through hole on the first main surface side has a diameter of about 100 to 150 μm, the diameter of the filler may be set to about 210 to 240 μm.

Furthermore, in the method for manufacturing a circuit board of the present invention, it is preferable that the value obtained by dividing the thermal expansion coefficient of the insulating substrate by that of the filler is 1.1 to 2.0, and more preferably 1.4 to 2.0. When this condition is satisfied, the filler is pressed by the inner wall of the through hole in the step of filling the filler, so that the hermeticity of the through hole is improved further.

Next, an electronic component of the present invention will be described. The electronic component of the present invention is an electronic component that includes the above-described circuit board of the present invention. Accordingly, the description of the same components as those of the above-described circuit board of the present invention may be omitted in the following description.

The electronic component of the present invention includes the above-described circuit board of the present invention, an electronic element that is mounted on this circuit board, and a lid member that covers this electronic element. In the circuit board included in the electronic component of the present invention, as described above, the hermeticity of the through hole is high. Therefore, according to the present invention, it is possible to provide an electronic component having high airtightness.

As the electronic element, for example, a quartz strip, a semiconductor element, or the like can be used. For example, when the electronic element is a quartz strip, the electronic component serves as a quartz oscillator. The material of the lid member can be, but is not particularly limited to, glass or the like, for example. The thickness of the lid member is about 0.3 to 0.4 mm.

Hereinafter, embodiment of the present invention will be described with reference to the accompanying drawings.

### Embodiment 1

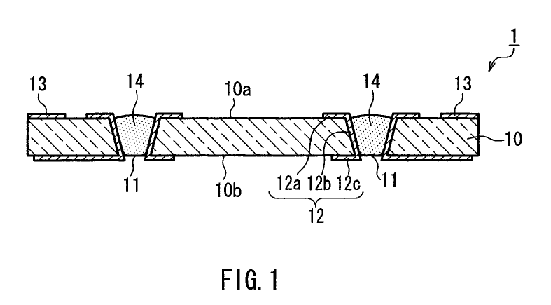

Embodiment 1 of the present invention will be described first with reference to the drawings. FIG. 1 referred to is a cross sectional view of a circuit board according to Embodiment 1 of the present invention.

As shown in FIG. 1, a circuit board 1 according to Embodiment 1 includes an insulating substrate 10, through holes 11 for connecting a first main surface 10a of the insulating substrate 10 to a second main surface 10b of the insulating substrate 10 that are formed in the thickness direction of the insulating substrate 10, a first conductive film 12, a second conductive film 13, and a filler 14 that is filled in the through holes 11. The filler 14 is filled in a non-foamed state. Thereby, it is possible to improve the hermeticity of the through holes 11. Particularly, it is preferable that the filler 14, which is filled in the through holes 11, has a porosity of not greater than 20% (more preferably, not greater than 10%) because the hermeticity of the through holes 11 is improved further.

The first conductive film 12 includes an electronic element connection electrode 12a that is formed around the opening of the through hole 11 on the first main surface 10a, a connection conductive film 12b that is formed on the inner wall of the through holes 11, and an external connection electrode 12c that is formed around the opening of the through holes 11 on the second main surface 10b. The first conductive film 12 corresponds to the “conductive film” recited in the appended claims.

Next, an example of each component of the above circuit board 1 will be described. As the insulating substrate 10, for example, a glass substrate (thickness: 150 μm) made of borosilicate glass having a thermal expansion coefficient of 7×10⁻⁶/° C. and a softening point of 730° C. can be used. The diameter of the through hole 11 decreases gradually from the first main surface 10a toward the second main surface 10b. The diameter of the opening on the first main surface 10a side is, for example, 150 μm, and the diameter of the opening on the second main surface 10b side is, for example, 50 μm. As the filler 14, for example, a filler made of borosilicate glass having a thermal expansion coefficient of 5×10⁻⁶/° C. and a softening point of 650° C. can be used.

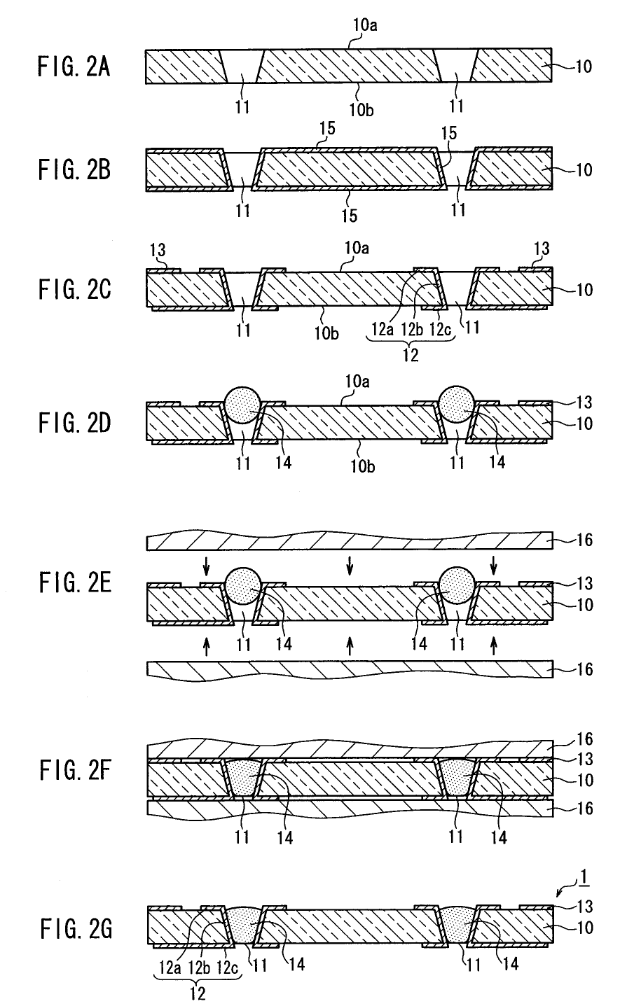

Next, an example of a method for manufacturing the above circuit board 1 will be described. FIGS. 2A to 2G referred to are cross sectional views used to illustrate an example of a method for manufacturing the circuit board 1. In FIGS. 2A to 2G, the same reference numerals are given to the same components as those of FIG. 1, and a description thereof may be omitted.

First, as shown in FIG. 2A, through holes 11 are formed in the thickness direction of an insulating substrate 10 to connect a first main surface 10a of the insulating substrate 10 to a second main surface 10b of the insulating substrate 10. The through holes 11 can be formed by, for example, a sandblast method using a medium such as alumina or silicon carbide.

Subsequently, as shown in FIG. 2B, a conductive film 15 is formed on the surfaces of the insulating substrate 10 and the inner walls of the through holes 11. The conductive film 15 is formed to have a thickness of about 1 μm by, for example, a sputtering method.

Then, after a resist film (not shown) is formed on a predetermined portion of the conductive film 15, the portion of the conductive film 15 that is not covered with the resist film is etched to form first and second conductive films 12 and 13 shown in FIG. 2C.

Thereafter, as shown in FIG. 2D, a filler 14 that is made of glass and is formed to have a substantially spherical shape is placed on the openings of the through holes 11 on the first main surface 10a side. In this case, as the filler 14, for example, BH glass manufactured by Nippon Electric Glass Co., Ltd. can be used. The diameter of the filler 14 may be, for example, about 210 μm when the diameter of the openings of the through holes 11 on the first main surface 10a side is 150 μm.

Then, the filler 14 is compressed while being heated, using a pressing jig 16 (FIGS. 2E to 2F). The heating temperature of the filler 14 may be, for example, a temperature (e.g., about 600 to 630° C.) not greater than the softening point of the filler 14. The pressure for the compression using the pressing jig 16 may be, for example, about 4.0×10⁸ to 1.1×10¹⁰ Pa. Thereby, the filler 14 is filled in a non-foamed state (FIG. 2G). As the component material of the pressing jig 16, for example, a material in which the surface of a core material made of a superhard material obtained by sintering TiC or the like is covered with diamond-like carbon or the like can be used.

Furthermore, in the above manufacturing method, when each component material is selected such that the value obtained by dividing the thermal expansion coefficient of the insulating substrate 10 by that of the filler 14 falls within a range of 1.1 to 2.0, the filler 14 is pressed by the inner wall of the through hole 11 in the filling step. This further increases the hermeticity of the through hole 11.

Furthermore, in the above manufacturing method, when using a conductive film made of a metal on which an oxide coating film is formed easily as the first conductive film 12 (conductive film 15), the adhesion between the filler 14 (glass) and the first conductive film 12 is improved, further increasing the hermeticity of the through hole 11.

### Embodiment 2

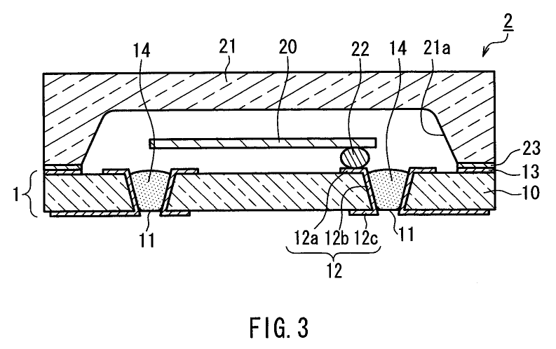

Next, Embodiment 2 of the present invention will be described with reference to the drawings. FIG. 3 referred to is a cross sectional view of an electronic component according to Embodiment 2 of the present invention. The electronic component according to Embodiment 2 includes the circuit board 1 according to Embodiment 1 described above. In FIG. 3, the same reference numerals are given to the same components as those of FIG. 1, and a description thereof may be omitted.

As shown in FIG. 3, an electronic component 2 according to Embodiment 2 includes the circuit board 1 according to Embodiment 1 described above, an electronic element 20 that is mounted on the circuit board 1, and a lid member 21 that covers the electronic element 20. The lid member 21 has a recessed portion 21a that is formed by means of a sandblast method, etching method, or the like. The electronic element 20 is mounted on the electronic element connection electrode 12a via a conductive adhesive 22. The second conductive film 13 and the lid member 21 are bonded via an adhesion layer 23. As the component material of the adhesion layer 23, a gold-tin plated film, a gold-tin paste, low-melting glass, or the like can be used. As described above, because the electronic component 2 according to Embodiment 2 includes the above-described circuit board 1 according to Embodiment 1 of the present invention, the improvement of airtightness can be achieved.

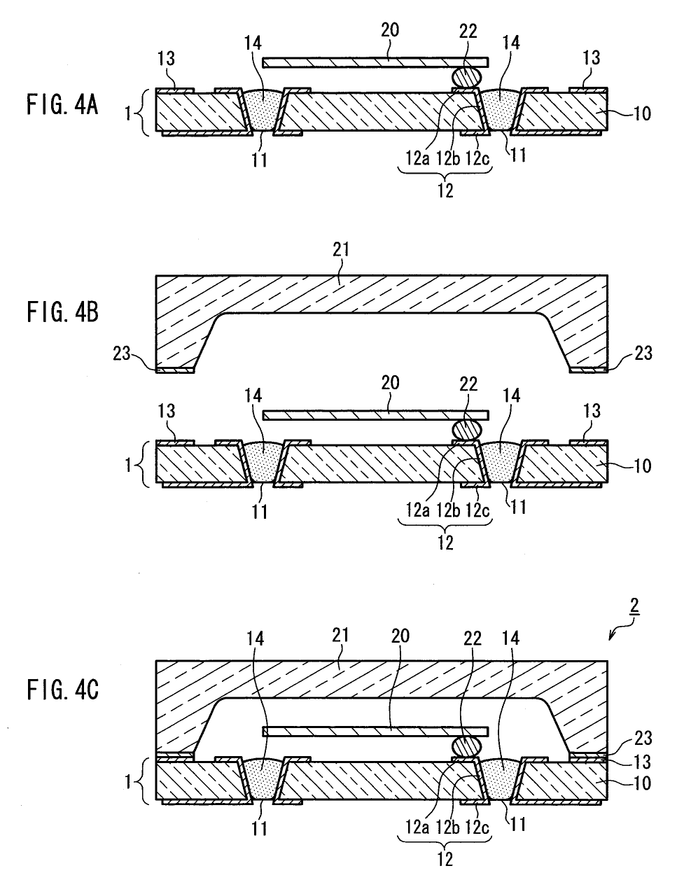

Next, an example of a method for manufacturing the above electronic component 2 of Embodiment 2 will be described with reference to the drawings. FIGS. 4A to 4C referred to are cross sectional views used to illustrate an example of a method for manufacturing the electronic component 2 of Embodiment 2. In FIGS. 4A to 4C, the same reference numerals are given to the same components as those of FIG. 3, and a description thereof may be omitted.

First, as shown in FIG. 4A, an electronic element 20 is mounted on the electronic element connection electrode 12a of the circuit board 1 via a conductive adhesive 22. Thereby, the external connection electrode 12c of the circuit board 1 is connected electrically to the electronic element 20 via a connection conductive film 12b, an electronic element connection electrode 12a and the conductive adhesive 22.

Subsequently, the circuit board 1 is placed in a positioning jig (not shown) in a vacuum atmosphere, after which a lid member 21 is positioned above the circuit board 1 (see FIG. 4B), and then the lid member 21 and the circuit board 1 are bonded. In this step, as shown in FIG. 4B, an adhesion layer 23 is provided in advance on the connecting portion of the lid member 21 to the circuit board 1. In this embodiment, as the adhesion layer 23, a gold-tin alloy (thickness: 10 to 15 μm) formed by electroplating is used. In this case, the mass ratio (gold:tin) of the gold-tin alloy may be set to, for example, 4:1.

Thereafter, the lid member 21 is heated together with the circuit board 1 in a N₂ gas atmosphere furnace held at 290 to 310° C. with the application of a pressure of 5×10⁴ to 6×10⁴ Pa. The heating time in this case preferably is 30 to 60 seconds. Thereby, the circuit board 1 and the lid member 21 are bonded to each other by the adhesion layer 23. Thus, an electronic component 2 having high airtightness is obtained (FIG. 4C).

The obtained electronic component 2 was exposed to high humidity conditions of the unsaturated vapor pressure test (test conditions: 130° C., a relative humidity (RH) of 85%, 40 hours) in accordance with IEC (International Electorotechnical Commission) 68-2-66, after which an airtightness test was performed (100 pieces for each). As a result, it was confirmed that the electronic components 2 exhibited good airtightness. As used herein, the expression “the airtightness is good” means a state in which a leakage amount of not greater than 1×10⁻⁹ Pa·m³/sec is retained in an airtightness tester that utilizes helium as a tracer gas. The above airtightness test is a test in accordance with JISZ2331 “helium leakage testing method (vacuum spraying method)”, and was performed using a helium leak detector manufactured by ULVAC, Inc. as the airtightness tester. In the electronic components 2 used in the test, the filler 14 had a porosity of 20%.

For comparison, an electronic component was manufactured in the same manner as the electronic component 2 that was used in the above test was manufactured, except that the through holes were hermetically sealed with a glass paste (FX-10-026 manufactured by NIPPON FIELD ENGINEERING Co., Ltd.) as the filler according to the method described in Background Art, and then was subjected to the above airtightness test (100 pieces for each). As a result, the electronic components exhibited a leakage amount of 1×10⁻⁶ Pa·m³/sec. In the electronic components of the comparative example used in the test, the filler had a porosity of 40%.

### INDUSTRIAL APPLICABILITY

The present invention is useful for an electronic component that includes a quartz strip, a semiconductor element, or the like, and is particularly useful for an electronic component that is required to have high airtightness.

1. A circuit board comprising an insulating substrate, and a through hole that is formed in the thickness direction of the insulating substrate for connecting a first main surface of the insulating substrate to a second main surface of the insulating substrate, wherein the circuit board comprises:
a conductive film that is formed on the inner wall of the through hole and around the openings of the through hole on the first and second main surface; and
a filler that is filled in the through hole,
the filler is filled in a non-foamed state,
the insulating substrate is a glass substrate,
the filler is made of glass, and
the softening point of the filler is lower than the softening point of the insulating substrate.

2. The circuit board according to claim 1, wherein the filler filled in the through hole has a porosity of not greater than 20%.

3. (canceled)

4. (canceled)

5. The circuit board according to claim 1, wherein the diameter of the through hole decreases gradually from the first main surface toward the second main surface.

6. A method for manufacturing a circuit board comprising the steps of:
forming a through hole in the thickness direction of the insulating substrate for connecting a first main surface of an insulating substrate to a second main surface of the insulating substrate;
forming a conductive film on the inner wall of the through hole and around the openings of the through hole on the first and second main surfaces; and
filling a filler into the through hole,
wherein the insulating substrate is a glass substrate,
the filler is made of glass,
the softening point of the filler is lower than the softening point of the insulating substrate, and
the filler is filled into the through hole with the application of heat and pressure.

7. (canceled)

8. (canceled)

9. The method for manufacturing a circuit board according to claim 6, wherein the filler in a substantially spherical shape is filled into the through hole.

10. The method for manufacturing a circuit board according to claim 6, wherein the through hole is formed such that the diameter of the through hole decreases gradually from the first main surface toward the second main surface.

11. The method for manufacturing a circuit board according to claim 6, wherein the value obtained by dividing the thermal expansion coefficient of the insulating substrate by the thermal expansion coefficient of the filler is 1.1 to 2.0.

12. An electronic component comprising:
a circuit board that comprises an insulating substrate, and a through hole that is formed in the thickness direction of the insulating substrate for connecting a first main surface of the insulating substrate to a second main surface of the insulating substrate;
an electronic element that is mounted on the circuit board; and
a lid member that covers the electronic element,
wherein the circuit board comprises a conductive film that is formed on the inner wall of the through hole and around the openings of the through hole on the first and second main surfaces, and a filler that is filled in the through hole,
the filler is filled in a non-foamed state,
the insulating substrate is a glass substrate,
the filler is made of glass, and
the softening point of the filler is lower than the softening point of the insulating substrate.
